(19) United States
(12) Patent Application Publication
(10) Pub. No.: US 2003/0040975 A1
(43) Pub. Date: Feb. 27, 2003

(54) Method and device for providing a product while allowing said product to develop

(76) Inventor: Frederic Baron, Saint-Nom-La-Breteche (FR)

Correspondence Address: MARSHALL, GERSTEIN & BORUN, 6300 SEARS TOWER, 233 SOUTH WACKER, CHICAGO, IL, 60606-6357, US

(21) Appl. No.: 10/129,865

(22) PCT Filed: Oct. 17, 2001
(86) PCT No.: PCT/FR01/03209

(30) Foreign Application Priority Data
Oct. 27, 2000 (FR) 0013822

(51) Int. Cl. G06F 17/60

(52) U.S. Cl. 705/26

(57) ABSTRACT

The process is implemented by a service provider by means of a computer system (4) for procuring a product offered by a supplier, for a customer benefiting from capital able to cover a purchase value of the product. The process comprises steps for linking (14) a savings account in which said capital is placed, to collateral in respect of financing ensured by the service provider, linking (25) the financing to an option of future redemption of said offered product and to a periodic charging schedule in respect of said customer, and triggering (24) a payment of the purchase value by means of the financing so as to procure the offered product.

The computer system (4) comprises a memory structure containing a collateral link (27) between a first data structure relating to a savings account in which is placed capital able to cover a purchase value of the product and a second data structure relating to a financing of the acquisition, a debit link (28) between the second data structure and a third data structure relating to a periodic charging schedule, an upgrade link (45) between the second data structure and a fourth data structure relating to an option of redemption of the product, an arithmetic and logic processing unit (20) envisaged for triggering a payment of said acquisition by means of the financing and for activating the debit link (28).

The field of application of the invention is that of processes and devices for procuring products for customers.

Electronic trade allows for example a customer to select products from catalogs broadcast over the Internet open network and to make an online payment by means of a credit card. The products thus purchased are delivered to the customer by various state of the art means.

In a more traditional setting, the customer goes to a trader from whom he takes possession of a purchased product by paying the cash price thereof or by paying on credit by means of a loan.

In either case, in order to benefit from a product acquisition on his behalf, a customer has to hand over a certain sum of money in order to pay the price of the product.

This presents a drawback when dealing with rapidly obsolete products such as, for example, computer products, office products, photographic products, home automation products, video products, electrical domestic products, etc. Knowing that the sum of money which he has to lay out in order to make use of the product is entirely lost, the customer may tend to postpone his purchase while waiting for a higher-performance product. The constantly refreshed prospect of better products to come may lead certain customers to ultimately do without a product which they wish to make use of although they possess a sufficient sum of money to cover the purchase thereof. Such a customer then prefers to deposit this sum of money in a savings account which has the advantage of gaining interest and of thus increasing his funds, as opposed to acquiring a product which he interprets as impermanent. The drawback is that the customer does not make use of the progress in the art although he possesses the sum of money allowing him to.

Procuring a product by means of a sale in which the customer gives a sum of money in exchange for delivery of the product, is not appropriate in this case.

In a known manner, rental allows the product to be procured for the customer without him needing to discharge a sum of money corresponding to the price of the product, in order to commence use thereof. However, this poses a technical problem in respect of products of a movable nature, whose location or proper maintenance is difficult to control. The recovery of the product at the end or in case of breach of the rental contract, requires sophisticated logistical means. Provision must be made to be able to track the location of the product and then to be able to travel to an identified site in order to take back the product. A means of identification by radio waves on the product, logged in a database, would run the risk of increasing the cost of the product considerably. Moreover, such a means might be deficient if it were removed from the product. Assuming that the cost of implementing sophisticated logistical means does not exceed the cost of the product itself, these means may not afford complete satisfaction if the product recovered is in a poor condition or destroyed.

Again in a known manner, a loan allows the product to be procured for the customer without him needing to discharge a sum of money corresponding to the price of the product, in order to commence use thereof. Whereas for immovable goods whose location is by nature fixed, it is easy for the lender to take a guarantee for the goods themselves, a guarantee for products of a movable nature, such as commonly consumed goods, creates technical problems when exercising this guarantee. Here again, sophisticated logistical means are required together with a device for definite locating of the product and means for traveling to a recognized site in order to take repossession of the product.

Another problem which arises is also that of concern for the environment caused by obsolescence or degradation of commonly consumed products. Without suitable means of recovery of these products, the latter represent useless clutter for a person in possession thereof or a risk of pointless environmental pollution by scrapping or by destruction when harmful products remain. The known means of sorting waste are sometimes difficult to implement in a completely suitable manner.

An aim of the invention is to procure a product for a customer without the customer having to part with a sum of money covering a product acquisition price, at the time when the product is procured, doing so with an upgrade capability so as to benefit from progress in the art.

An aim of the invention is also to make it possible to upgrade a product by replacing it with a higher-performance product while checking what happens to the replaced product.

A subject of the invention is a process implemented by a service provider by means of a computer system for procuring a product offered by a supplier, for a customer benefiting from capital able to cover a purchase value of said product. The process comprises a step for linking a savings account in which said capital is deposited, to collateral in respect of financing ensured by the service provider, a step for linking said financing to an option of future redemption of said offered product and to a periodic charging schedule in respect of said customer, and a step for triggering a payment of said purchase value by means of said financing so as to procure said offered product.

Thus, by virtue of the process implemented by the service provider, the customer does not lay out the capital corresponding to the purchase price of the product. This capital, deposited in a savings account, gains interest from which the customer can benefit. The price of the product is paid not through loss of capital but by means of the financing ensured by the service provider.

The customer simply pays a periodic charge to cover use of the product. Moreover, the customer is assisted by the option of redeeming the offered product which he can exercise at any time during the financing, so as to transfer the financing to a new product which profits from the progress in the art. At the end of financing, the capital from which the customer benefits is not eroded by the use of the product but may possibly be increased by the interest accrued.

For the service provider, the financing is made secure through the capital deposited in the savings account. The collateral link allows him to pay off directly any outstanding liabilities should the customer default. This first automatic mechanism thus avoids the need for the service provider to put in place complex and expensive logistical means for recovering the product whose condition and physical location cannot be established in an obvious manner. Especially beneficial in the field of mass distribution where any expenditure on the provision of security to ensure any outstanding payments, represents a considerable share of the cost price of the product, the first automatic mechanism made possible by linking the savings account to collateral in a computer system, allows the product to be procured at less expense.

A second automatic mechanism is made possible by linking, in the computer system, the financing to an option of future redemption of the product. When exercised voluntarily by the customer in a positive context of upgrade, the redemption option affords the service provider automatic recovery of the product which it is then in the customer's interest to locate under the best terms and in the best possible condition.

Advantageously, the process according to the invention comprises a step for deducting, from the periodic charging schedule, an amount corresponding to a redemption value of an old product.

Thus, when the customer wishes to replace an old product which has become obsolete with a new product, the financing pertains to the new product. If the financing already pertained to the old product, the financing is transferred to the new product. The replacement of the old product by the new product is not lost, since the redemption value serves to reduce the periodic charge for upgrading the product.

Another subject of the invention is a computer system for financing a product acquisition on behalf of a customer. The computer system comprises a memory structure containing a collateral link between a first data structure relating to a savings account in which is deposited capital able to cover a purchase value of said product and a second data structure relating to a financing of said acquisition, a debit link between the second data structure and a third data structure relating to a periodic charging schedule, an upgrade link between the second data structure and a fourth data structure relating to an option of redemption of said product, an arithmetic and logic processing unit provided for triggering a payment of said acquisition by means of said financing and for activating the debit link.

Other aspects of the invention will emerge from the following description of an exemplary embodiment, by way of illustration with reference to the figures where:

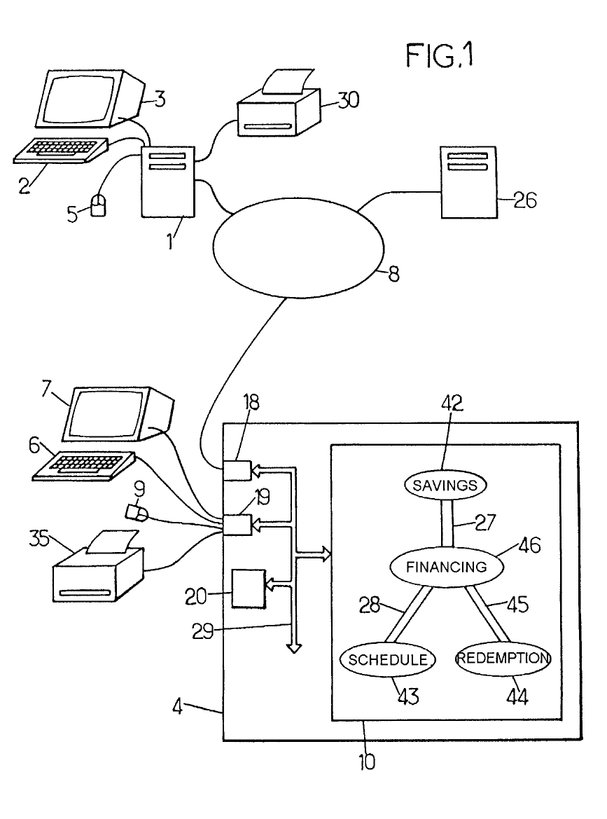

FIG. 1 presents a computer system in accordance with the invention;

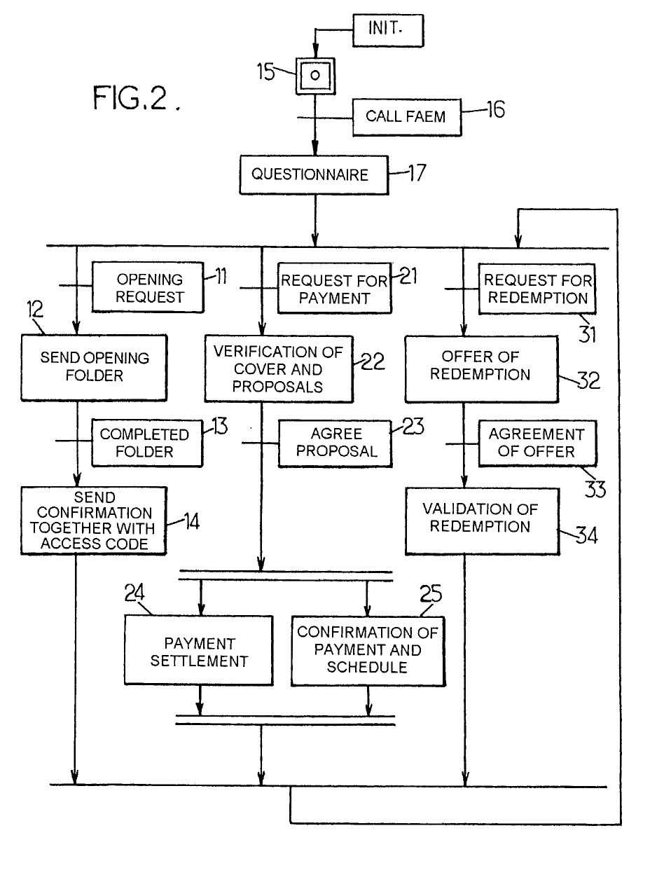

FIG. 2 presents process steps in accordance with the invention;

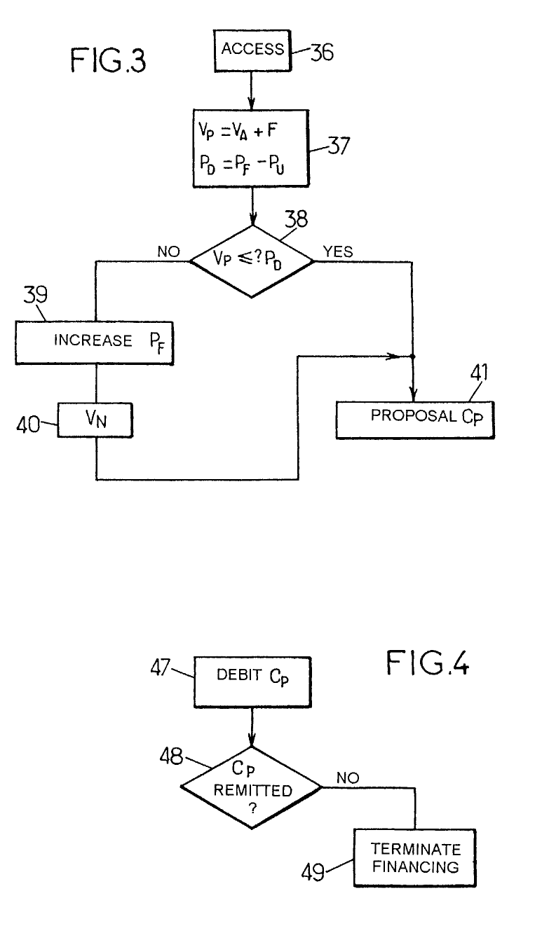

FIG. 3 presents a succession of steps for drawing up a periodic charging schedule;

FIG. 4 presents a succession of steps activated in the course of financing.

With reference to FIG. 1, a computer 1 is connected to a keyboard 2, a screen 3, a mouse 5 and a communication network 8. A computer system 4 is likewise connected to the communication network 8.

The computer system 4 comprises an arithmetic and logic processing unit 20 consisting of one or more processors, which is connected by a bus 29 to a memory 10, an input output circuit 19 and a communication circuit 18. The communication circuit 18 connects the computer system 4 to the network 8. The input output circuit 19 connects the computer system 4 to a screen 7, a keyboard 6 and a mouse 9. The memory 10 is to be taken in the widest sense, that is to say it covers both a work memory such as a random access memory and also a mass memory such as disks or magnetic tapes.

With reference to FIG. 2, the computer system 4 operates in server mode, listening for messages which arrive from the network 8 on the communication circuit 18.

A process in accordance with the invention is implemented in the computer system 4 by means of a server application initially in a waiting step 15. The server application is executed by the arithmetic and logic processing unit 20 by means of programs resident in the memory 10.

A transition 16 switches the server application from step 15 to step 17. The transition 16 is activated by the arrival of a call request on the circuit 18.

This call request is issued on the network 8 from the computer 1. It is triggered by a customer in front of the screen 3, by means of the keyboard 2 and/or the mouse 5. The customer plans to buy a product and therefore envisages benefiting from the process in accordance with the invention.

The computer 1 may be situated at the customer's home or in a point of sale. From his home, the customer consults for example online sales catalogs which draw his attention to a product. From a point of sale, a trader invites the customer to buy a product by means of the process of the invention.

In step 17, the system 4 issues a questionnaire on the network 8 destined for the computer 1 by means of the circuit 18. The questionnaire takes the form for example of a page in the known HTML format which is displayed on the screen 3.

The page of the questionnaire comprises for example three buttons. A first button corresponds to a request to open a financing plan in respect of a person whose name is to be registered in a first box alongside the first button. A second button corresponds to a request for payment by means of an already open financing plan whose references are to be registered in a second box alongside the second button. A third button corresponds to a request for redemption of an old product whose references are to be registered in a third box alongside the third button.

A click on the first button, possible only if the first box is filled in, causes a message to be issued on the network 8 whose reception in the system 4 validates a transition 11. The message thus issued contains the information registered in the first box. The message issued by the computer 1 is for example received from the network 8 by means of the communication circuit 18.

A click on the second button, possible only if at least the second box and possibly the first box are filled in, causes a message to be issued on the network 8 whose reception in the system 4 validates a transition 21. The message thus issued contains the information registered in the second box and possibly that registered in the first box.

A click on the third button, possible only if at least the second box and possibly the first or the third box are filled in, causes a message to be issued on the network 8 whose reception in the system 4 validates a transition 31. The message thus issued contains the information registered in the second box and possibly that registered in the first or the third box.

The transition 11 switches the server application from step 17 to a step 12.

In step 12, the system 4 issues an opening folder, on the network 8, destined for the computer 1, by means of the circuit 18. The opening folder takes the form for example of a page in the known HTML format which is displayed on the screen 3.

The page of the opening folder comprises various boxes in which information is usefully registered in order to open a financing plan in accordance with the process according to the invention.

For example, a first group of boxes serves to identify the customer by his name, his address, or even his civil status. A second group of boxes serves to define a desired financing potential P_{F}, that is to say a sum of money to cover one or more purchases of products. The second group of boxes also serves to define a desired periodic charging amount Cₚ in the form of a threshold or percentage. A third group of boxes serves to define a savings account owned by the customer and to conclude a collateral contract with regard to the savings account so as to secure the financing potential. A fourth group of boxes is envisaged for opening a savings account if an available one does not already exist. The page of the opening folder also comprises for each group of boxes the useful particulars such as, for example, contractual conditions. The page of the opening folder can comprise other groups of boxes, for example for marketing purposes.

The customer has various possibilities for filling in the opening folder.

According to a first possibility, the customer fills in the various boxes online by means of the keyboard 2. The customer then appends an electronic signature to the group or groups of boxes which require his consent then sends in secure mode over the network 8, destined for the computer system 4, the completed page of the opening folder.

According to another possibility, the customer prints the opening folder by means of a printer 30 connected up to the computer 1. The customer fills in, possibly by hand, boxes which he has not filled in by means of the keyboard 2. The customer affixes his handwritten signature at various prescribed places in the printed document. The customer then sends the completed and signed printed document back to the service provider, who implements the process according to the invention. When the service provider receives the signed printed document, he inputs the various particulars registered on the printed document, by means of the keyboard 6, of the screen 7 and/or of the mouse 9 which are connected up to the computer system 4.

The receipt of the completed folder by the system 4, by means of the circuit 18 according to the first possibility or of the circuit 19 according to the other possibility, activates a transition 13.

Provision may also be made in step 12 to establish a dialog between the computer 1 and the system 4 so as to perform simulations of a periodic charging schedule. If the customer has traveled to the service provider's premises, these simulations may also be carried out by way of the keyboard 6, of the screen 7 and of the mouse 9.

The transition 13 switches the server application from step 12 to a step 14.

In step 14, the computer system 4 verifies that the capital deposited in the savings account whose references are carried in the completed and signed folder, is sufficient to secure the financing potential. If need be, the computer system 4 interrogates another computer system 26 which contains the data relating to the savings account. The computer system 26 is for example under the supervision of a financial organization which manages the savings account.

Within a structure of the memory 10, the computer system 4 creates a first data structure 42 relating to the savings account and a second data structure 46 relating to the financing. The first data structure 42 contains, for example, the references of the savings account, the amount of capital deposited in the savings account, the customer's particulars. The computer system 4 calculates a financing folder reference number and a confidential code for accessing the financing folder, which are stored in the second data structure 46. The computer system 4 then creates a collateral link 27 between the first and the second data structure, so as to link the savings account in which the capital is deposited, to the financing ensured by the service provider. The collateral link 27 contains the electronic signature of the customer or a reference for the printed document to which the customer's handwritten signature is attached according to the mode chosen to validate the customer's consent with regard to a collateral contract. In a manner known in cryptography, a customer's electronic signature authenticates his agreement with regard to an electronic document which here describes the terms of the collateral contract. The collateral link 27 contains a pointer to the first data structure and a pointer to the second data structure. If need be, the link 27 also contains a communication address of the computer system 4 and a communication address for the computer system 26. In this case, an image of the link 27 in the computer system 26 guarantees the collateral by the financial organization.

Within the structure of the memory 10, the computer system 4 creates a third data structure 43 relating to a periodic charging schedule. The third data structure 43 is intended to contain a product acquisition value, a charging amount to be remitted by the customer, computed as a function of the acquisition value and of the financial fees, as well as a frequency of remittance. The computer system 4 then creates a debit link 28 between the second and the third data structure, so as to link the financing to the periodic charging schedule. The debit link 28 contains the electronic signature of the customer or a reference for a printed document to which the customer's handwritten signature is attached according to the mode chosen to validate the consent of the customer with regard to the periodic charging schedule. The debit link 28 contains a pointer to the second data structure 46 and a pointer to the third data structure 43. The debit link contains the references of a current account of the customer to be debited in order to remit the periodic charge. If need be, for example if the current account is managed by the financial organization by means of the computer system 26, the debit link 28 also contains a communication address of the computer system 4 and a communication address of the computer system 26.

Within the structure of the memory 10, the computer system 4 creates a fourth data structure 44 relating to a product redemption option. The fourth data structure 44 is intended to contain references and a date of acquisition of the procured product. The computer system 4 then creates an upgrade link 45 between the second and the fourth data structure, so as to link the financing to the redemption option. The upgrade link 45 contains a pointer to the second data structure 46 and a pointer to the fourth data structure 44. The upgrade link 45 makes it possible to evaluate, in the course of financing, for example by means of a pointer to a market database, a product redemption value at a date on which the redemption option is exercised by the customer.

The computer system 4 then sends in encrypted mode to the computer 1, via the network 8, the reference number of the financing folder together with the confidential access code and the amount of the financing potential. Provision may also be made for the computer system 4 to print the abovementioned data by means of a printer 35 connected up to the circuit 19. The document printed by means of the printer 35 is then sent back to the customer, by hand or by post.

Thus, the memory 10 of the computer system 4 is structured in such a way as to contain a link 27 between the savings account and the financing for which a collateralized value V_{N} is defined, resulting from the desired financing potential P_{F}. The collateralized value is computed by the arithmetic and logic processing unit 20, generally by adding management fees to the financing potential P_{F}. Initially, the used part P_{U} of the financing potential is zero. The link 27 is envisaged for allowing a lender organization to withdraw the collateralized value from the savings account should the customer default.

The terms for validating a financing potential are fulfilled when the links 27 and 28 exist and when the savings account is in credit by an amount greater than the financing potential P_{F}.

The receipt of the reference number of the financing folder by the customer allows him to validate the second and/or the third button of the questionnaire issued in step 17.

The transition 21 switches the server application from step 17 to a step 22. As described above, the transition 21 is validated by a click on the second button of the questionnaire when the second box is filled in with the references of a financing plan. Provision may be made for a fourth box in which the customer registers a purchase value VA of the product to be bought, by means of the keyboard 2. Provision may also be made for the purchase value VA to be registered automatically alongside the second button, in conjunction for example with an electronic trade application.

In step 22, the computer system 4 verifies the existence of sufficient cover of the purchase value VA by the financing plan whose references are received in the message which validated the transition 21. The computer system 4 then sends the computer 1 a periodic charging schedule proposal.

Step 22 is for example executed by the arithmetic and logic processing unit 20 by means of one or more programs residing in the memory 10, the essential steps of which are presented with reference to FIG. 3.

The financing plan such as it results from step 14 can be accessed in one or more data files, addressed in the memory 10 of the computer system 4, by means of the second data structure 46. The memory 10 should be taken here in its widest sense, that is to say the memory 10 comprises both the random access memory and the addressable mass memory of the computer system 4.

With reference to FIG. 3, a step 36 is envisaged for opening the data file or files corresponding to the financing plan referenced by the transition 21, so as to access the financing plan data such as the financing potential P_{F}, a collateralized value V_{N}, the link 28 to a periodic charging schedule.

In a step 37, a loan value V_{P} is computed by adding management fees F to the purchase value V_{A}. An available part P_{D} of the financing potential is computed by subtracting a financing potential used part P_{U}, if it exists, from the financing potential P_{F}.

In a step 38, the loaned value V_{P} is compared with the available part P_{D}. If the loaned value V_{P} is not less than the available part P_{D}, an intermediate step 39 is executed.

In step 39, the computer system 4 generates a proposal to increase the financing potential P_{F} so that the loan value V_{P} is less than the available part P_{D} of the financing potential. If need be, the proposal to increase the financing potential is accompanied by a request for additional depositing in the savings account so that the total value deposited in the savings account is always greater than the financing potential P_{F}.

If in step 39 no increase in the financing potential is effected, the program of FIG. 3 and consequently step 22 are suspended.

Following an increase in financing potential in step 39, in accordance with that requested, in a step 40, the arithmetic and logic processing unit 20 recomputes the collateral value V_{N} and updates the link 27.

When the available part P_{D} of the financing potential is greater than the loan value V_{P} in step 38 or 40, the arithmetic and logic processing unit 20 computes, in a step 41, a periodic charge to be remitted by the customer so as to generate a schedule which regularly decreases the used part P_{U} of the financing potential. The schedule generated is displayed on the screen 3 by the circuit 18 and the network 8, on the screen 7 and/or on the printer 35 by the circuit 19, so as to be proposed to the customer.

To mark his agreement to the proposed schedule, the customer communicates, preferably in encrypted form, the confidential code which was given to him in step 14, to the computer system 4.

The receipt by the computer system 4 of the confidential code and of the particulars of the product supplier, validates a transition 23 which switches the server application from step 22 to two steps 24 and 25.

In step 24, the computer system 4 settles up with the supplier whose particulars validated the transition 23, by paying him the purchase value V_{A}.

In step 25, the computer system 4 confirms to the customer that the payment has been made by sending a confirmation message to the computer 1 via the circuit 18 and the network 8 for display on the screen 3, via the circuit 19 to the screen 7 or to the printer 35 for posting. Simultaneously, the computer system 4 completes the fourth data structure with the references of the product paid for in step 24 and the date of payment. The computer system 4 validates the link 28 by inserting therein the schedule's signature obtained by means of the confidential code transmitted.

So long as the financing of the procured product is not discharged, the link 28 is periodically revived by the computer system 4 which triggers automatic execution of steps described with reference to FIG. 4.

A step 47 is envisaged for making a request for debit of the customer's current account, equal to the periodic charge Cₚ, such as it is owing according to the schedule.

A step 48 is envisaged for verifying that the periodic charge is remitted in accordance with the schedule. If the periodic charge is correctly remitted, the financing is continued normally without particular action.

If in step 48 the periodic charge is not remitted, that is to say should the customer default, a step 49 is envisaged for automatically terminating the financing.

In step 48, the collateral link 27 is activated so as to pay off the schedule by removing the sums still owing from the savings account. The ownership of the procured product is then assigned to the customer. That is to say that if the customer already owns the product, for example in the case of a financing of a purchase on credit, no material action is triggered. If the customer does not own the product, for example if the financing concerns a rental, a transfer of ownership of the product to the customer is triggered automatically.

With reference to FIG. 2, the transition 31 switches the server application from step 17 to a step 32.

As described above, the message validating the transition 31 contains the references of a financing folder which are registered in the second box. If the customer wishes to redeem all the products previously acquired by means of the process and still in his use, the references of these products are already logged in the financing folder. The references of the financing folder which are registered in the second box are then sufficient to redeem all the products. If the customer wishes to redeem one or more specified products, acquired previously by means of the process, or in the customer's possession upon the opening of the financing plan, the references of this or of these products are registered in the third box.

In step 32, a redemption value V_{R} of the product or products which results from the transition 31 is computed by means of the link 45. If the validation of the transition 31 is concomitant with the validation of the transition 11, the redemption can also pertain to a product acquired without financing by the service provider, which product the customer wishes to upgrade by means of the financing ensured by the service provider. The computer system 4 generates a redemption offer which quotes the computed redemption value V_{R}. The redemption value serves to make an early payment of periodic charges with regard to the schedule specified in step 22. This makes it possible to trim the periodic charges of the schedule for an acquisition of new products. The redemption offer is then transmitted by the computer system 4 to the customer.

Advantageously, the computer system 4 issues the redemption offer on the network 8 destined for the computer 1. This makes it possible to display the redemption offer on the screen 3, for example in the form of a page in the HTML format. The customer can thus give his agreement to the offer by clicking on a button reserved for this purpose.

A receipt of agreement to the offer received by the computer system 4 validates a transition 33. Advantageously, in order to send his agreement, the customer is obliged to include therein a site address at which the product is made available for redemption. This site is for example the customer's home or a depot to which it is proposed to bring the product. For example, the communication circuit 18 is devised to receive, from the network 8, a message issued by the computer 1. This message then contains the site address at which the product is made available.

The transition 33 switches the computer system 4 from step 32 to a step 34.

In step 34, the computer system 4 validates the redemption of the product or products. In particular, the computer system 4 effects a transfer of ownership to a party redeeming the redeemed product or products. The computer system 4 deducts the redemption value V_{R} from the schedule. The computer system 4 next informs the customer of the validation of the redemption. The computer system 4 also automatically informs a redeeming party who then has the particulars of the site at which to redeem the product. For example, the communication circuit 18 is devised so as to communicate the site address to the redeeming party over the network 8 so as to allow him to recover the product therefrom. Site address communication can also be effected on the screen 7 or on the printer 35, which are activated by the keyboard 6 or the mouse 9, so as to draw up a waybill transmitted to the redeeming party. In the case of the replacement of a redeemed old product with a new product, the logistics of redeeming the old product and of delivery are optimized by communicating the identical same site address to a haulier so as to recover the old product and deliver the new product. The computer system then allows automatic generation of a removal order together with the exact particulars of the removal and of the delivery to another system so as to respond to the problem of the collection of mass-market equipment comprising the product, with a view to reconditioning or recycling.

Advantageously, the computer system 4 issues the validation of the redemption on the network 8 destined for the computer 1. This makes it possible to display the validation of offer on the screen 3, for example in the form of an HTML page. This page then contains the modifications of the financing plan which result from the options chosen.

The implementation of the process described with reference to the figures allows the customer to effect:

a request for payment by means of an already existing financing plan by validation of the transition 21;

an early opening of a financing plan by validation of the transition 11;

an opening of financing plan with request for payment by validation of the transition 11 and then of the transition 21;

an opening of financing plan with request for redemption by validation of the transition 11 and then of the transition 31;

a request for payment by means of an existing financing plan with request for redemption by validation of the transition 31 and then of the transition 21;

an opening of plan with request for payment and for redemption by validation of the transition 11, of the transition 31 and then of the transition 21.

Benefitting from the teaching set forth hereinabove, the person skilled in the art can readily contemplate other variants of the process and of the system described above, without departing from the scope of the present invention. For example, it is conceivable to replace the mouse or the keyboard by voice recognition or biometric means, to effect the communication with the computer system by means of cellular telephony. The computer system can be distributed among several server machines.

The process and the system which were described above have a beneficial industrial application since they allow simple traceability of products procured for customers without having to implement technically complicated logistical means. Specifically, it is the customer himself who ensures the possibility of retrieving the product since it is in his interest to trade it in and to do so in the best possible condition.

Even if the product is beyond use, a minimum redemption value makes it possible for example to induce the customer to return the product. This is especially beneficial with regard to the sorting of waste which requires industrial solutions for reconciling the spread of consumption and concern for the environment. The product being logged in the central system, it is easily possible to determine the best destination thereof during its recovery.

1. A process implemented by a service provider by means of a computer system (4) for procuring a product offered by a supplier, for a customer benefiting from capital able to cover a purchase value of said product, characterized in that it comprises steps for:
linking (14) a savings account in which said capital is deposited, to collateral in respect of financing ensured by the service provider;
linking (25) said financing to an option of future redemption of said offered product and to a periodic charging schedule in respect of said customer;
triggering (24) a payment of said purchase value by means of said financing so as to procure said offered product.

2. The process for procuring a product as claimed in claim 1, characterized in that it comprises a step (34) for allocating said financing a redemption value of the procured product or of another product previously procured for the customer.

3. The process for procuring a product as claimed in claim 2, characterized in that it comprises:
a transition (33) validated by an agreement received regarding the redemption value, said agreement comprising a site address at which said product is made available;
a step (34) activated by the transition (33) for transmitting said site address to a redeeming party so as to allow him to recover said product.

4. The process for procuring a product as claimed in claim 1 or 2, characterized in that it comprises steps for:
verifying (48) in the course of financing that a periodic charge of said schedule is remitted;
terminating (49) said financing if said periodic charge is not remitted, by automatically paying off said schedule by means of the collateral and by assigning ownership of said procured product to the customer.

5. The process for procuring a product as claimed in one of the preceding claims, characterized in that it comprises a step (17) for sending from said computer system (4) to a computer (1) accessed by said customer, a questionnaire allowing the customer to request financing, a payment of the offered product or a redemption of another product by means of the computer (1).

6. The process for procuring a product as claimed in one of the preceding claims, characterized in that it comprises a step (12) for collecting data relating to the savings account, in a memory (10) of said computer system (4).

7. A computer system (4) for financing a product acquisition on behalf of a customer, characterized in that it comprises:
a memory structure containing a collateral link (27) between a first data structure relating to a savings account in which is deposited capital able to cover a purchase value of said product and a second data structure relating to a financing of said acquisition, a debit link (28) between the second data structure and a third data structure relating to a periodic charging schedule, an upgrade link (45) between the second data structure and a fourth data structure relating to an option of redemption of said product;
an arithmetic and logic processing unit (20) envisaged for triggering a payment of said acquisition by means of said financing and for activating the debit link (28).

8. The computer system (4) for financing a product acquisition on behalf of a customer as claimed in claim 7, characterized in that it comprises a communication circuit (18) for receiving from a network (8) a message issued by a computer (1), said message containing a request for financing, for payment of said acquisition or for redemption of another product.

9. The computer system (4) for financing a product acquisition on behalf of a customer as claimed in claim 7, characterized in that it comprises a communication circuit (18) for receiving from a network (8) a message issued by a computer (1), said message containing a site address at which said product is made available, and for communicating said site address to a redeeming party so as to allow him to recover said product.

10. The computer system (4) for financing a product acquisition on behalf of a customer as claimed in claim 8, characterized in that the arithmetic and logic processing unit (20) triggers the payment of said acquisition by means of said financing and activates the debit link (28) when said message contains a request for payment.

11. The computer system (4) for financing a product acquisition on behalf of a customer as claimed in claim 8, characterized in that the arithmetic and logic processing unit (20) activates the upgrade link (45) when said message contains a request for redemption.

12. The computer system (4) for financing a product acquisition on behalf of a customer as claimed in one of claims 7 to 11, characterized in that the arithmetic and logic processing unit (20) activates the collateral link (27) should the customer default.
